(19) United States
(12) Patent Application Publication
(10) Pub. No.: US 2013/0075118 A1
(43) Pub. Date: Mar. 28, 2013

(54) SOIL CULTIVATION TOOL DEVICE

(71) Applicant: Roger Pellenc, Pertuis (FR)

(72) Inventor: Roger Pellenc, Pertuis (FR)

(73) Assignee: PELLENC (SOCIETE ANONYME), Pertuis (FR)

(21) Appl. No.: 13/642,611

(22) PCT Filed: Apr. 20, 2011
(86) PCT No.: PCT/FR2011/050910

§ 371 Date: Dec. 17, 2012

(30) Foreign Application Priority Data
Apr. 21, 2010 (FR) 1053029

(51) Int. Cl. A01B 1/06

(52) U.S. Cl. CPC A01B 1/06; A01B 1/065
USPC 172/41; 172/377; 172/720

(57) ABSTRACT

The invention relates to a hand tool or power tool device for cultivating the ground and soil, such as a hoe or hoeing tool, scraper, or the like, essentially comprising a working tool that is releasably or permanently mounted at the front end of a handle or the like which optionally has one or more specific holding zones or grips. The working tool is essentially composed of a bent integral or welded multipart metal strip to form a U-shaped lower section (6), at least part of which is used for cutting, and a shaped upper section to be mounted at the front end (3′) of the handle (3). The strip section extends between the legs of the U-shaped section (6), forms the core of the U, and has a serrated profile including teeth on the opposite longitudinal edges thereof, said teeth being preferably staggered. The device (1) is characterized in that said strip section is sharp at the two opposite longitudinal edges thereof.

This invention relates to the field of implements and gardening tools and for working fields and grounds, and more generally the hand-operated or motor-driven tool devices used by private individuals and/or professionals for cultivation of soil and ground that is bare, cultivated, planted or fallow.

The invention encompasses more particularly a hand-operated or motor-driven ground and soil cultivation tool device.

Numerous variant embodiments of tools of this type are already known, with entirely hand-operated handling or with motor-driven assistance.

These tools have diverse shapes, in particular at the end that works the soil, as a function of the nature of the work to be performed, and optionally of the nature of the soil and the plant cover of the place to be treated.

Thus, in particular, there are known hoes that are used to loosen the earth more or less deeply, hoes or hoeing tools that loosen the earth on the surface and cut the weeds at least partially, weeding hoes that more specifically make it possible to remove the weeds, claws that break up the compact soils and aerate them, or else edge-finishing tools.

Since these tools are relatively specialized in their respective functions, it is often necessary to use several of them in succession to achieve a complete treatment and an adequate preparation of the ground.

Thus, there exists a demand for a soil and ground cultivation tool that makes it possible to achieve simultaneously at least several of the above-cited different functions, all while exhibiting a simple construction and having a low cost.

In this context, the document U.S. Pat. No. 3,965,991 has proposed a hoe equipped with an elongated handle, at the end of which is placed a cutting tool, with the ability to rotate around an axis perpendicular to said handle. The latter has a blade bent in the shape of a U and inserted by its ends into the two free ends of a flattened tube, itself also bent in U-shape, the core of the latter being solid with the handle.

Likewise, FR-A-2 394 971 discloses a hoe with a construction similar to the one described above. The cutting tool, itself also slightly mobile in rotation, consists of a blade bent in the shape of a U, but whose wings are bent at their end in a way that is parallel to the base of the U. It is at these two ends that the blade is then taken between two metal plates that are secured to the handle of the device.

By the documents GB-A-682 536 and DE-C-964 545, we know, furthermore, soil cultivation tools of the hoe type mounted on a corresponding handle and whose active part in the form of a horizontal blade exhibits a wavy or jagged profile.

However, it turns out during use that these known hoes do not have an optimal working effectiveness, in particular as regards the severing of roots and/or the possibility of a reversible operation.

This invention has as its object to eliminate the limitations of these known tools.

For this purpose, the invention has as its object a hand-operated or motor-driven ground and soil cultivation tool device such as a hoe, hoeing tool, scraper or the like, essentially comprising a work tool that is mounted, in a removable way or not, at the front end of a handle or the like, equipped or not with one or more specific gripping zones or handles, said work tool being essentially composed of a metal band, all in one piece and bent or assembled by welding several parts to constitute a U-shaped lower part, at least partially sharp, and an upper part shaped for a mounting on the front end of the handle,

a device characterized in that the band portion that extends between the branches of the U-shaped part and that forms the base of the latter comprises a jagged profile with teeth at its two opposite longitudinal edges, preferentially placed in staggered rows, and

in that said band portion is sharp at its two opposite longitudinal edges, particularly at the level of sharp teeth 11.

The invention will be better understood thanks to the description below, which relates to preferred embodiments, given by way of nonlimiting examples, and explained with reference to the accompanying diagrammatic drawings, in which:

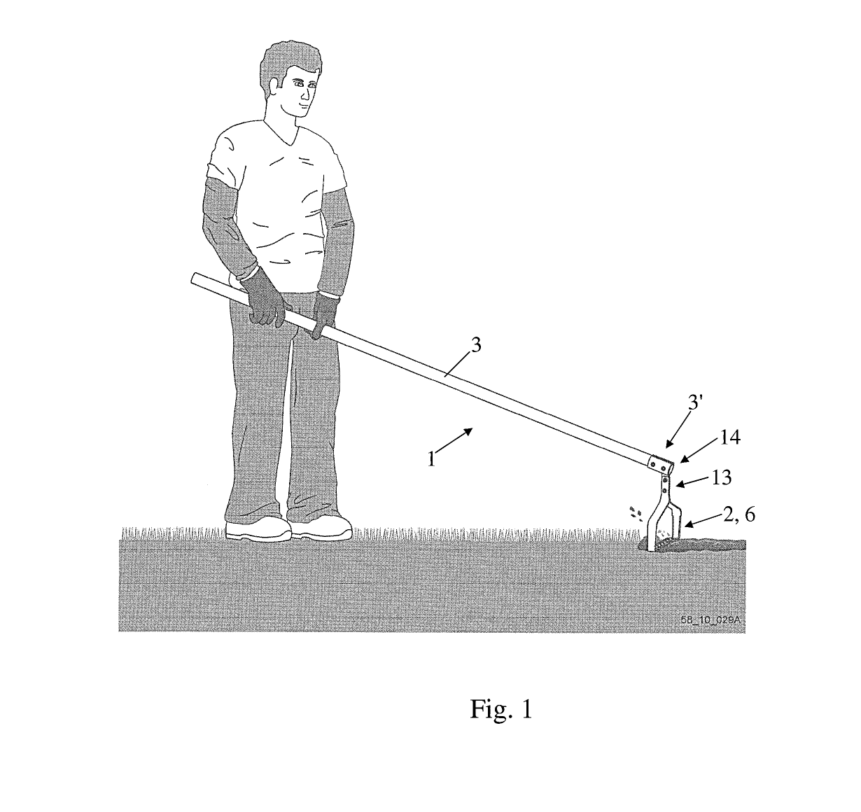

FIG. 1 is a perspective view of a hand tool device or tool device with hand-operated handling according to a first embodiment of the invention, during use;

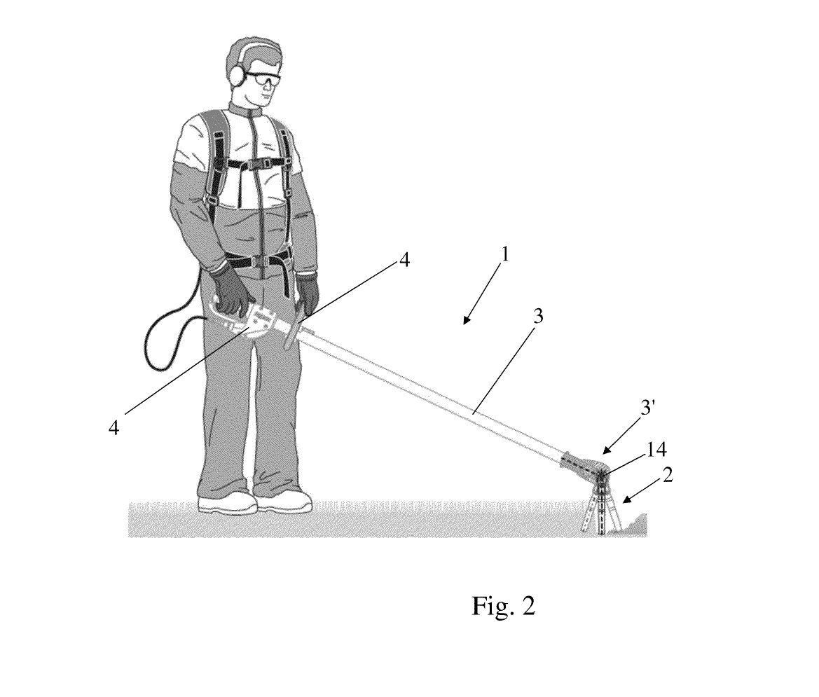

FIG. 2 is a perspective view of a motor-driven tool device according to a second embodiment of the invention, during use;

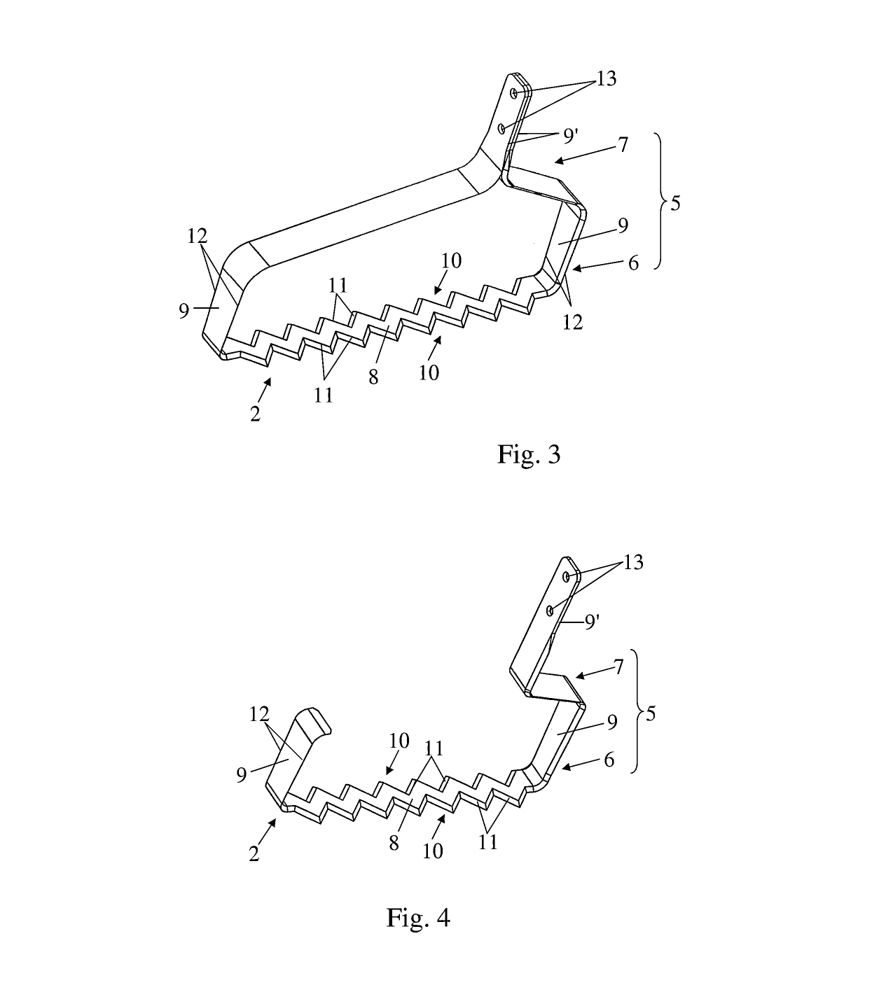

FIGS. 3 to 5 are perspective views of different embodiments of the work tool that is part of the device according to the invention, in particular as shown in FIGS. 1 and 2;

FIGS. 6 to 8 are frontal elevation views of three design variants of the work tool shown in FIG. 3, being differentiated by their connecting and fastening interface;

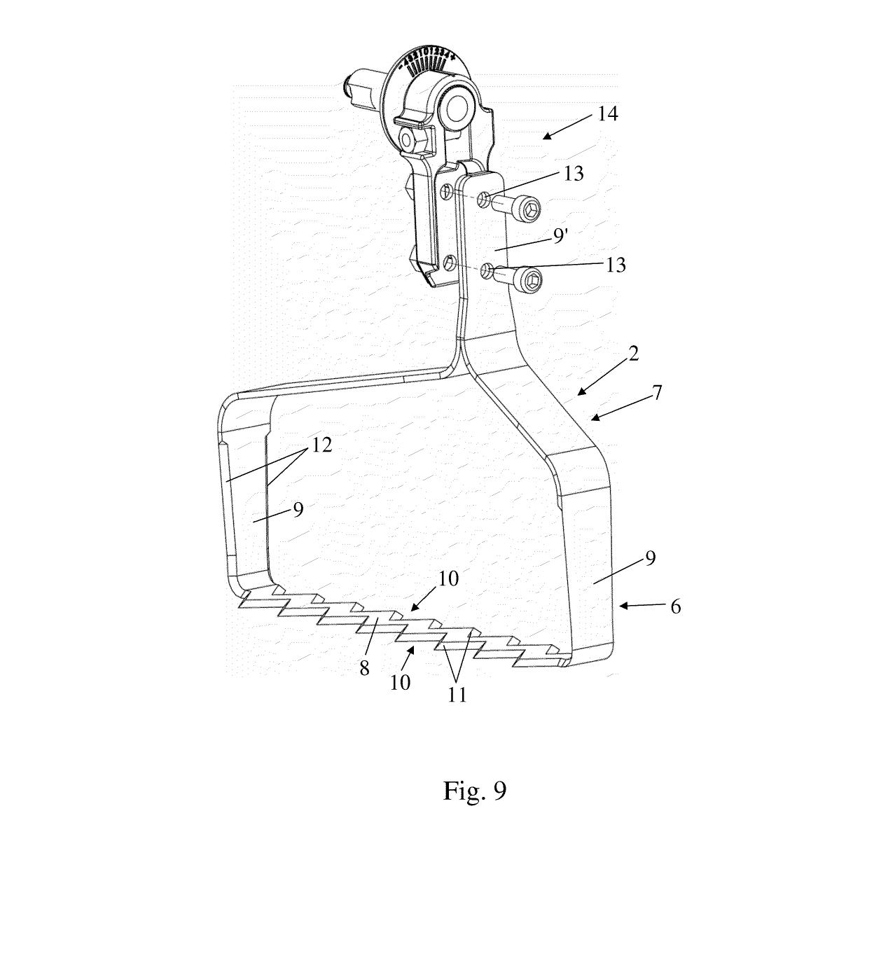

FIG. 9 is an exploded perspective view illustrating the work tool of FIG. 3 associated with a connecting and fastening interface, according to an embodiment of the device according to the invention as illustrated in FIG. 2, and,

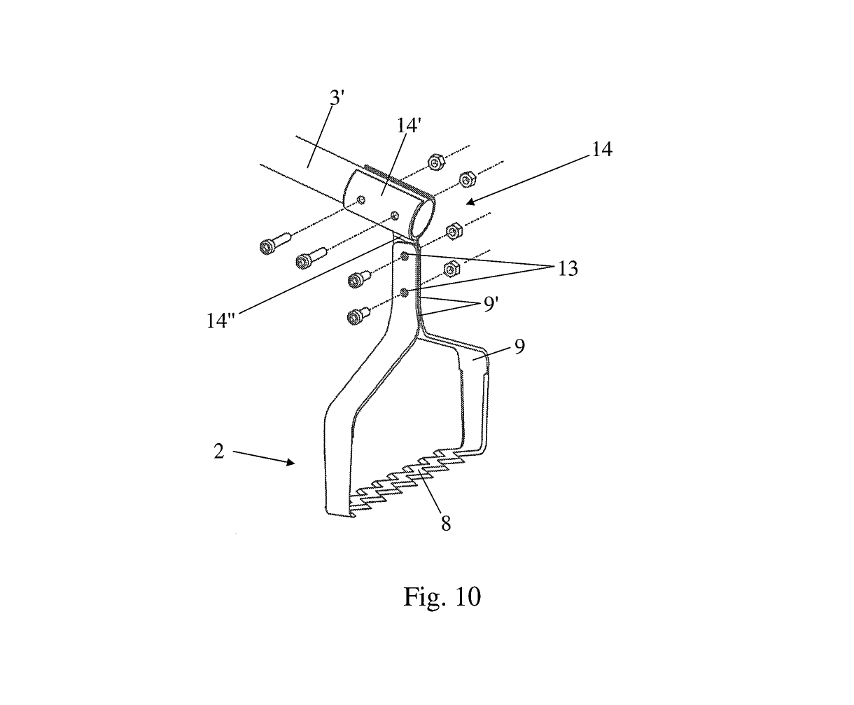

FIG. 10 is a detail view on another scale of the front end of the handle and of the work tool of the tool device shown in FIG. 1.

FIGS. 1, 2 and 10 of the accompanying drawings show a hand-operated or motor-driven ground and soil cultivation tool device 1, such as a hoe, hoeing tool, scraper or the like, essentially comprising a work tool 2 that is mounted, in a removable way or not, at the front end 3′ of a handle 3 or the like, provided or not with one or more specific gripping zones or handles 4.

As FIGS. 3 to 9 of the drawings show, this work tool 2 is essentially composed of a metal band 5, all in one piece and bent or assembled by welding several parts to make a U-shaped lower part 6, at least partially sharp, and an upper part 7 shaped for a mounting on the front end 3′ of the handle 3.

According to the invention, the band portion 8 that extends between the branches 9 of the U-shaped part 6 and that forms the base of the latter is sharp at its two opposite longitudinal edges 10, and these edges 10 have a non-linear profile with a jagged configuration.

The provision of edges 10 with jagged profiles, i.e., the edge directed toward the user during use and the opposite edge, makes it possible to facilitate and to optimize the severing of roots (because of carrying out a slicing movement) and to make the movement of the work tool 2 in the soil easier.

Furthermore, with the two cutting edges 10, it is possible to use the work tool 2 in two opposite mounting arrangements (turning the work tool 2 180°).

In addition, the tool 2 works in the two directions of movement (when it approaches the user and when it moves away from him).

The band portion that forms the flat base 8 of the U has a jagged profile with teeth 11 at the level of its two opposite longitudinal edges 10, and the band portions 9 that form the branches of the U are sharp at the level of their two longitudinal edges 12, providing cutting teeth.

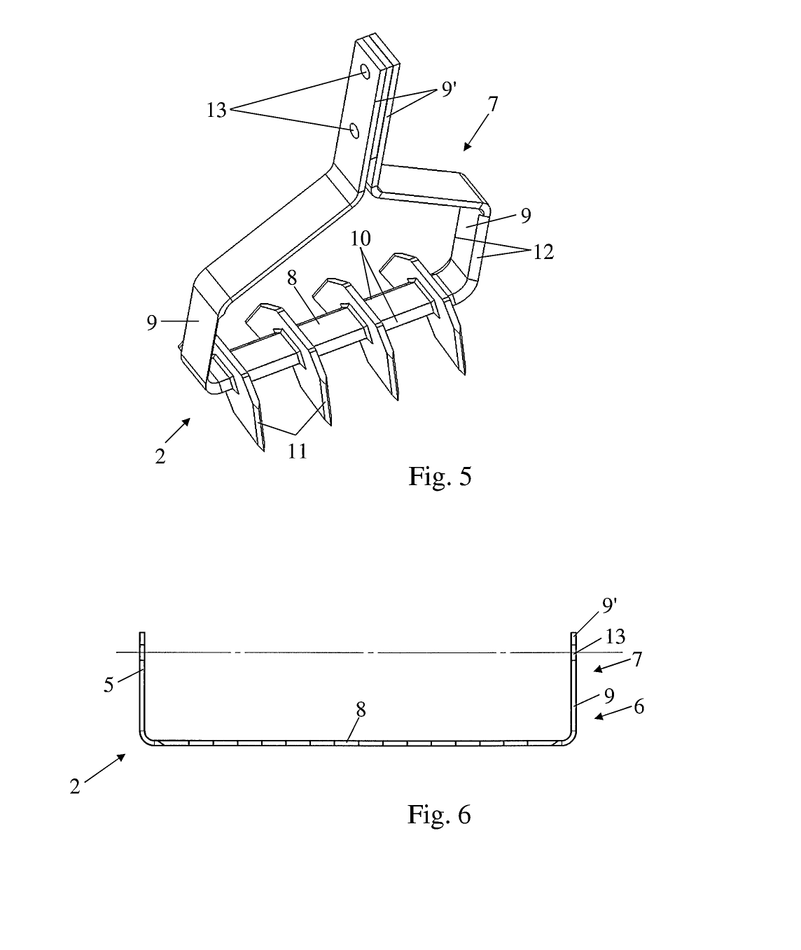

The teeth 11 can, as FIG. 5 shows, be attached (for example, by welding), in a right-angle orientation, on the portion of the band 8 that forms the cutting base of the U-shaped part 6 of the tool 2, positively active for cultivating the soil during use of the tool device 1.

In conformity with the invention in its preferred embodiment, however, and as FIGS. 3, 4 and 9 of the drawings show, the teeth 11, advantageously of triangular shape, are cut into the portion of band 8 that forms the flat base of the U, the latter exhibiting an arrangement of staggered rows of teeth 11 along the opposite edges 10 giving the base a general zigzag shape, with its two opposite cutting and sharp edges 10 having jagged profiles.

The two longitudinal edges 10 of the base 8 thus exhibit a plurality of elementary oblique cutting blades, mutually offset from one edge to the next, provided by the teeth 11.

The work tool 2 is shaped so as to have sufficient free space at its upper part 7 to allow in particular the passage of cut plants and grass and thus to avoid jamming.

Various methods of assembling the work tool 2 with the handle 3 can be envisaged, and their practical realization is part of the normal professional knowledge of a person skilled in the art.

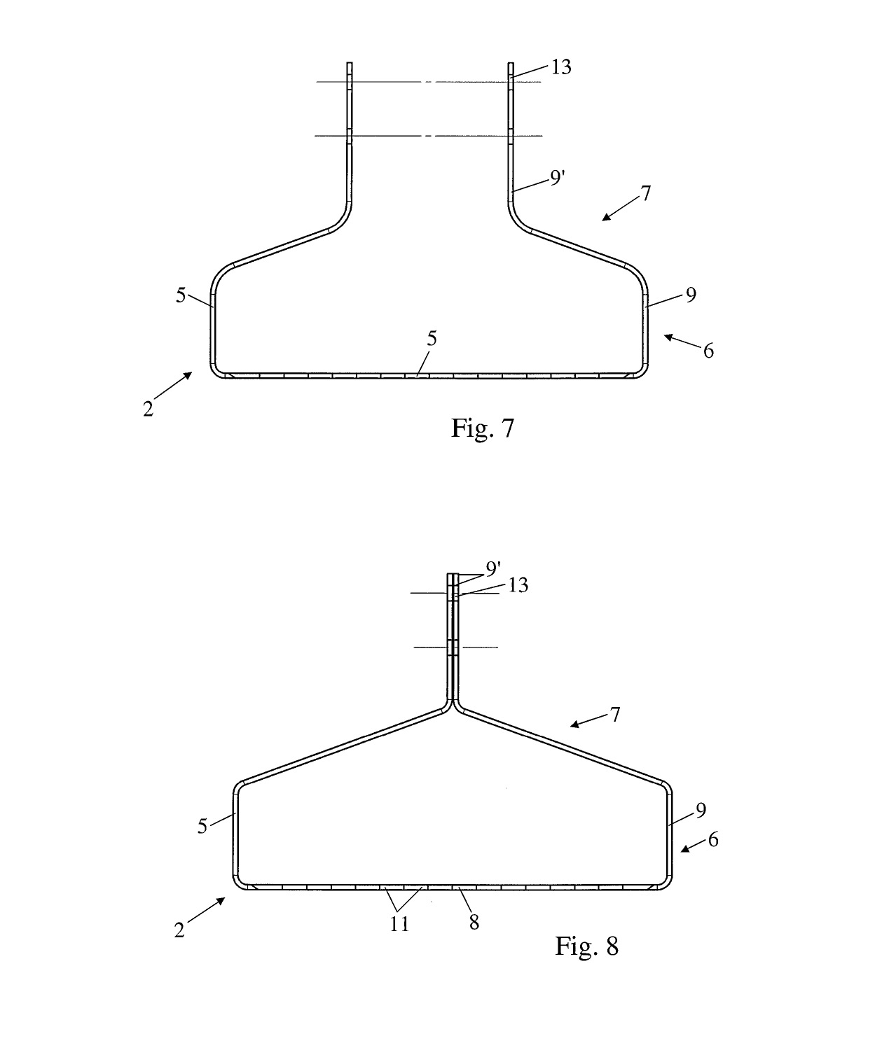

Thus, according to a first variant, evident from FIGS. 6 and 7, the upper part 7 of the work tool 2 shaped for a mounting on the end 3′ of the handle 3 has two connecting and fastening sites 13 that are spaced apart and located at the ends of extensions 9′ of the two branches 9 of the U that forms the sharp lower part 6.

According to a second variant, evident from FIGS. 3, 4, 5, 8 and 9, the upper part 7 of the work tool 2 shaped for mounting on the handle 3 comprises a single connecting and fastening site 13, centered or not in relation to the U and located at the end of the extension 9′ of at least one of the two branches 9 of the U that forms the sharp lower part 6. The size and the shape of the work tool 2 are thus totally free and independent of the fastening method.

In the two aforementioned cases, the work tool 2 integrates its component of the mounting interface onto the handle 3.

Also, different shapes of work tools 2 can be designed within the framework of the characteristics mentioned above.

In conformity with a first constructive variant, illustrated in FIGS. 3, 5, 8 and 9, the work tool 2 exhibits a loop shape, with a rectangular U-shaped sharp base 6 and with a tapered upper part 7, at least partially closed on itself, the opposite ends 13 of the metal band constituting being in contact with each other or separate.

In conformity with a second constructive variant, only one of the two branches 9 of the U that forms the sharp lower part 6 of the work tool 2 is extended by a band portion 9′ that forms a connecting and fastening bracket, the work tool 2 exhibiting an open structure with one-sided fastening (FIG. 4).

To make using the device 1 as user-friendly as possible and to permit it to be adapted to different users, it is advantageously provided that the means 14 for mounting and fastening the work tool 2 on the handle 3 allow an adjustment, with removable locking in position, of the angle of inclination between said work tool 2 and said handle 3. It is thus possible to adapt the device 1 to users of different sizes or to adjust it to perform specific work requiring a specific inclination of the tool 2, for example for effective use of the two opposite cutting edges 10, also allowing a differentiated pull of the muscles by using a second active movement for working the soil (reciprocating movements of thrusting and pulling of the tool).

FIG. 1 illustrates a tool device 1 of the hand-operated type.

FIGS. 1 and 10 illustrate an example of assembly of a work tool 2 with a handle 3 for forming a hand-operated tool device 1.

In this practical embodiment, the tool 2 is formed by a metal band 5, which is all in one piece and bent, and comprises an upper part 7 with connecting and fastening sites 13, made at extensions 9′ of the two branches 9 of the U.

The work tool 2 exhibits a structure similar to the one shown in FIG. 7, the two ends 9′ not being connected, for example welded, to one another.

The mounting and fastening means 14 integral with the handle 3 consists of, as FIGS. 1 and 10 show, a split tubular sheath 14′ fastened by bolts to the end 3′ of the handle and equipped with a fastening bracket 14″. In the mounted state, this bracket 14″, which is pinched between the ends 9′ of the tool 2, is attached rigidly to the latter by bolt/nut sets that go through the sites 13.

A means for absorbing vibrations and/or impacts, if necessary adjustable in intensity, can optionally be provided at the handle 3 or the connecting interface between the handle 3 and the work tool 2 (not shown), without, however, reducing the effectiveness of the tool 2, nor compromising the transmission of forces to the latter.

This means can, for example, comprise anti-vibration parts (such as, for example, “silent blocs” [“silent blocks”] —registered trademark), a mount subjected to the action of a spring or incorporating a spring, a deformable metal part, an insert, or a spacer part made of rubber or of a resilient material or similar elastic material.

According to another embodiment, illustrated in FIG. 2, the tool device 1 can also consist of a handheld motor-driven ground and soil cultivation device, comprising, on the one hand, a handle 3 that comprises, at a first end, a gripping zone and/or at least one gripping element or a gripping handle 4 for the user, and, at the opposite end 3′, a head 14 to which the work tool 2 is attached by a rotary or pivoting connection.

The latter is, when said device 1 is used, driven with a reciprocating oscillating movement along a portion of rotation and around a specified middle angular position, under the action of the movement transmitted by a drive device comprising at least one electric actuator or a heat engine, the work tool 2 being connected to the head 14 in a removable way and the middle angular position of said work tool 2 being adjustable.

A handheld motor-driven device is in particular described in more detail in the French patent application No. 1053027 filed on Apr. 21, 2010 in the name of the applicant.

The invention also has as its object an interchangeable work tool 2 for a hand-operated or motor-driven ground and soil cultivation tool device 1 as previously described, said work tool 2 being designed to be mounted with rigid fastening on the handle 3 of said device 1.

This work tool 2 is essentially composed of a metal band 5, all in one piece and bent or resulting from the assembly of several parts, which constitutes a sharp U-shaped lower part 6 and an upper part 7 shaped for a mounting on the front end 3′ of the handle 3, the metal band portion 8 extending between the branches 9 of the U-shaped part 6 and forming the base of the latter comprising a jagged profile with teeth 11 at its two opposite lateral edges (10), preferentially arranged in a staggered row.

According to the invention, the band portion 8 is sharp at its two edges 10.

Moreover, said tool 2 can exhibit one or more of the additional characteristics mentioned above.

Of course, the invention is not limited to the embodiments described and shown in the accompanying drawings. Modifications remain possible, particularly from the standpoint of the make-up of the various elements or by substitution of technical equivalents, without thereby going outside the field of protection of the invention.

1. Hand-operated or motor-driven ground and soil cultivation tool device, such as a hoe, hoeing tool, scraper or the like, essentially comprising a work tool that is mounted, in a removable way or not, at the front end of a handle or the like, equipped or not with one or more specific gripping zones or handles,
said work tool (2) being essentially composed of a metal band (5), all in one piece and bent or assembled by welding several parts, to constitute a U-shaped lower part (6), at least partially sharp, and an upper part (7) shaped for mounting on the front end (3′) of the handle (3),
device characterized in that the band portion (8) that extends between the branches (9) of the U-shaped part (6) and that forms the base of the latter comprises a jagged profile with teeth (11) at its two opposite longitudinal edges (10), preferentially arranged in staggered rows, and in that said band portion (8) is sharp at its two opposite longitudinal edges (10), particularly at the level of the cutting teeth (11).

2. Tool device according to claim 1, wherein the band portions (9) that form the branches of the U are sharp at their two respective opposite longitudinal edges (12).

3. Tool device according to claim 1, wherein it comprises a means (14) for mounting and fastening the work tool (2) on the handle (3) allowing an adjustment, with removable locking in position, of the angle of inclination between said work tool (2) and said handle (3).

4. Tool device according to claim 1, wherein the upper part (7) of the work tool (2) shaped for mounting on the end (3′) of the handle (3) comprises two connecting and fastening sites (13) that are spaced apart and located at the ends of extensions (9′) of the two branches (9) of the U that forms the sharp lower part (6).

5. Tool device according to claim 1, wherein the upper part (7) of the work tool (2) shaped for a mounting on the handle (3) comprises a single connecting and fastening site (13), centered or not in relation to the U and located at the end of the extension (9′) of at least one of the two branches (9) of the U that forms the sharp lower part (6).

6. Tool device according to claim 1, wherein the work tool (2) exhibits a loop shape, with a rectangular U-shaped sharp base (6) and with a tapered upper part (7), at least partially closed on itself, the opposite ends (13) of the metal band constituting it being in contact with each other or separate.

7. Tool device according to claim 1, wherein only one of the two branches (9) of the U that forms the sharp lower part (6) of the work tool (2) is extended by a band portion (9′) that forms a connecting and fastening bracket, the work tool (2) exhibiting an open structure with one-sided fastening.

8. Tool device according to claim 1, wherein it comprises a means for absorbing vibrations and/or impacts, at the handle (3) or at the connecting interface between the handle (3) and the work tool (2).

9. Tool device according to claim 1, wherein it is of the hand-operated type.

10. Tool device according to claim 1, wherein it consists of a handheld motor-driven ground and soil cultivation device, comprising, on the one hand, a handle (3) that comprises, at a first end, a gripping zone and/or at least a gripping element or a handle (4) for the user, and, at the opposite end (3′), a head (14) to which the work tool (2) is attached by a rotary or pivoting connection, which tool, when said device (1) is used, is driven with a reciprocating oscillating movement along a portion of rotation and around a specified middle angular position, under the action of the movement transmitted by a drive device comprising at least one electric actuator or a heat engine, the work tool (2) being connected to the head (14) in a removable way and the middle angular position of said work tool (2) being adjustable.

11. Interchangeable work tool for a hand-operated or motor-driven ground and soil cultivation tool device according to claim 1,
said work tool (2) being designed to be mounted with rigid fastening on the handle (3) of said device (1) and being essentially composed of a metal band, all in one piece and bent or resulting from the assembly of several parts, which constitutes a sharp U-shaped lower part (6) and an upper part (7) shaped for mounting on the front end (3′) of the handle (3),
tool wherein the metal band portion (8) that extends between the branches (9) of the U-shaped part (6) and that forms the base of the latter comprises a jagged profile with teeth (11) at its two opposite lateral edges (10), preferentially arranged in a staggered row, and wherein said band portion (8) is sharp at the level of its two opposite longitudinal edges (10), in particular at the level of the cutting teeth (11).

12. Tool device according to claim 2, wherein it comprises a means (14) for mounting and fastening the work tool (2) on the handle (3) allowing an adjustment, with removable locking in position, of the angle of inclination between said work tool (2) and said handle (3).

13. Tool device according to claim 2, wherein the upper part (7) of the work tool (2) shaped for mounting on the end (3′) of the handle (3) comprises two connecting and fastening sites (13) that are spaced apart and located at the ends of extensions (9′) of the two branches (9) of the U that forms the sharp lower part (6).

14. Tool device according to claim 3, wherein the upper part (7) of the work tool (2) shaped for mounting on the end (3′) of the handle (3) comprises two connecting and fastening sites (13) that are spaced apart and located at the ends of extensions (9′) of the two branches (9) of the U that forms the sharp lower part (6).

15. Tool device according to claim 2, wherein the upper part (7) of the work tool (2) shaped for a mounting on the handle (3) comprises a single connecting and fastening site (13), centered or not in relation to the U and located at the end of the extension (9′) of at least one of the two branches (9) of the U that forms the sharp lower part (6).

16. Tool device according to claim 3, wherein the upper part (7) of the work tool (2) shaped for a mounting on the handle (3) comprises a single connecting and fastening site (13), centered or not in relation to the U and located at the end of the extension (9′) of at least one of the two branches (9) of the U that forms the sharp lower part (6).

17. Tool device according to claim 2, wherein the work tool (2) exhibits a loop shape, with a rectangular U-shaped sharp base (6) and with a tapered upper part (7), at least partially closed on itself, the opposite ends (13) of the metal band constituting it being in contact with each other or separate.

18. Tool device according to claim 3, wherein the work tool (2) exhibits a loop shape, with a rectangular U-shaped sharp base (6) and with a tapered upper part (7), at least partially closed on itself, the opposite ends (13) of the metal band constituting it being in contact with each other or separate.

19. Tool device according to claim 4, wherein the work tool (2) exhibits a loop shape, with a rectangular U-shaped sharp base (6) and with a tapered upper part (7), at least partially closed on itself, the opposite ends (13) of the metal band constituting it being in contact with each other or separate.

20. Tool device according to claim 5, wherein the work tool (2) exhibits a loop shape, with a rectangular U-shaped sharp base (6) and with a tapered upper part (7), at least partially closed on itself, the opposite ends (13) of the metal band constituting it being in contact with each other or separate.
